(19) United States
(12) Patent Application Publication
(10) Pub. No.: US 2024/0090090 A1
(43) Pub. Date: Mar. 14, 2024

(54) HEATER DEVICE

(71) Applicant: DENSO CORPORATION, Kariya-city (JP)

(72) Inventors: Yoshiyuki YOKOYAMA, Kariya-city (JP); Koji Ota, Kariya-city (JP); Taro Ogura, Kariya-city (JP); Fuminobu Mikami, Kariya-city (JP)

(21) Appl. No.: 18/510,357

(22) Filed: Nov. 15, 2023

Related U.S. Application Data
(63) Continuation of application No. PCT/JP22/21805, filed on May 27, 2022.

(30) Foreign Application Priority Data
Jun. 2, 2021 (JP) 2021-092834

(51) Int. Cl. H05B 3/84; H05B 1/02

(52) U.S. Cl. CPC H05B 3/84; H05B 1/0236; B60H 1/00735

(57) ABSTRACT

A transparent conductive film is disposed on the light-transmitting region of the windshield. A first electrode portion and a second electrode portion are arranged to face each other in a vertical direction of a vehicle. A third electrode portion and a fourth electrode portion are arranged to face each other in a direction crossing the vertical direction of the vehicle. A control device is capable of implementing multiple energization modes. In a first mode among the plurality of energization modes, one of the first electrode portion and the second electrode portion is set to a high potential and the other is set to a low potential, or one of the third electrode portion and the fourth electrode portion is set to a high potential and the other is set to a low potential.

### CROSS REFERENCE TO RELATED APPLICATIONS

This application is a continuation application of International Patent Application No. PCT/JP2022/021805 filed on May 27, 2022, which designated the U.S. and based on and claims the benefits of priority of Japanese Patent Application No. 2021-92834 filed on Jun. 2, 2021. The entire disclosure of all of the above applications is incorporated herein by reference.

### TECHNICAL FIELD

The present disclosure relates to a heater device provided on a windshield of a vehicle.

### BACKGROUND

Conventionally, there is known a heater device for heating a windshield of a vehicle to de-icing or de-fogging the windshield in winter.

### SUMMARY

An object of the present disclosure is to provide a heater device capable of partially heating a windshield.

According to one aspect of the present disclosure, a heater device for heating a windshield of a vehicle includes a transparent conductive film, a first electrode portion, a second electrode portion, a third electrode portion, a fourth electrode portion, and a control device. The transparent conductive film is arranged in the light-transmitting region of the windshield, and has a conductive material provided on one surface of a transparent substrate. The first electrode portion and the second electrode portion are arranged in the outer edge portion of the windshield so as to face each other in a vertical direction of the vehicle, and are electrically connected to the transparent conductive film. The third electrode portion and the fourth electrode portion are arranged to face each other in a direction intersecting the direction in which the first electrode portion and the second electrode portion face each other in the outer edge portion of the windshield, and are electrically connected to the transparent conductive film. The control device can execute a plurality of energization modes for energizing the transparent conductive film by setting the first to fourth electrode portions to a high potential, a low potential, or a non-energizing state. In a first mode among the plurality of energization modes, one of the first electrode portion and the second electrode portion is set to a high potential and the other is set to a low potential, or one of the third electrode portion and the fourth electrode portion is set to a high potential and the other is set to a low potential so as to energize the transparent conductive film. In a second mode among the plurality of energization modes, one of the first electrode portion and the second electrode portion is set to a high potential and one of the third electrode portion and the fourth electrode portion is set to a low potential, or one of the first electrode portion and the second electrode portion is set to a low potential and one of the third electrode portion and the fourth electrode portion is set to a high potential so as to energize the transparent conductive film.

### BRIEF DESCRIPTION OF THE DRAWINGS

FIG. 1 is a cross-sectional view of part of a vehicle equipped with a heater device according to a first embodiment;

FIG. 2A is a front view of a windshield according to the first embodiment;

FIG. 2B is a front view of a heater device according to the first embodiment;

FIG. 3 is a diagram for explaining an example of a first mode by the heater device according to the first embodiment;

FIG. 4 is a diagram for explaining another example of the first mode by the heater device according to the first embodiment;

FIG. 5 is a diagram for explaining an example of a second mode by the heater device according to the first embodiment;

FIG. 6 is a diagram for explaining another example of the second mode by the heater device according to the first embodiment;

FIG. 7A is a front view of a windshield according to a second embodiment;

FIG. 7B is a front view of a heater device according to the second embodiment;

FIG. 8 is a diagram for explaining an example of a first mode by the heater device according to the second embodiment;

FIG. 9 is a diagram for explaining another example of the first mode by the heater device according to the second embodiment;

FIG. 10 is a diagram for explaining an example of a third mode by the heater device according to the second embodiment;

FIG. 11 is a diagram for explaining another example of the third mode by the heater device according to the second embodiment;

FIG. 12 is a diagram for explaining an example of a fourth mode by the heater device according to the second embodiment;

FIG. 13 is a diagram for explaining orientation of a conductive material forming a transparent conductive film in a heater device according to a third embodiment;

FIG. 14 is an explanatory diagram of a method for calculating a degree of orientation of a conductive material forming a transparent conductive film;

FIG. 15 is a graph showing experimental results regarding the relationship between the degree of orientation of a conductive material forming a transparent conductive film and the resistance reduction rate of the transparent conductive film;

FIG. 16 is a diagram for explaining another example of the orientation of the conductive material forming the transparent conductive film in Modification 1 of the third embodiment;

FIG. 17 is a diagram for explaining another example of the orientation of the conductive material forming the transparent conductive film in Modification 2 of the third embodiment;

FIG. 18A is a front view of a windshield according to a fourth embodiment;

FIG. 18B is a front view of a heater device according to the fourth embodiment;

FIG. 19 is a diagram for explaining an example of a first mode by the heater device according to the fourth embodiment; and

FIG. 20 is a diagram for explaining an example of a second mode by the heater device according to the fourth embodiment.

### DETAILED DESCRIPTION

In an assumable example, there is known a heater device for heating a windshield of a vehicle to de-icing or de-fogging the windshield in winter. The heater device includes a plurality of resistive heating wires arranged over an entire translucent region of the windshield, and a plurality of electrodes arranged on an outer edge portion of the windshield and electrically connected to the resistive heating wires. In addition, the electrodes are called bus bars.

When heating the windshield, in the heater device, two electrodes arranged on the vehicle upper side and left and right sides of the outer edge portion of the windshield are set to a high potential, and two electrodes arranged on the vehicle lower side of the outer edge portion of the windshield are set to a low potential. Alternatively, when heating the windshield, in the heater device, the two electrodes arranged on the vehicle upper side and on the left and right sides of the outer edge portion of the windshield are set to a low potential, and the two electrodes arranged on the vehicle lower side of the outer edge portion of the windshield are set to a high potential. Thus, the heater device applies current to a plurality of resistive heating wires to heat the entire windshield. This heater device makes it possible to heat the entire windshield uniformly by adjusting a distance between a plurality of resistive heating wires or the wire diameter of a plurality of resistive heating wires in each region of the windshield.

By the way, in general, window fogging of the windshield of the vehicle is likely to occur mainly at corner portions. However, the heater device always heats the entire windshield, and cannot heat only the corner portions of the windshield where window fogging is likely to occur. Therefore, the heater device described in Patent Document 1 heats the entire windshield even when the windshield is prevented from fogging up while the vehicle is running, resulting in an increase in power consumption.

An object of the present disclosure is to provide a heater device capable of partially heating a windshield.

According to one aspect of the present disclosure, a heater device for heating a windshield of a vehicle includes a transparent conductive film, a first electrode portion, a second electrode portion, a third electrode portion, a fourth electrode portion, and a control device. The transparent conductive film is arranged in the light-transmitting region of the windshield, and has a conductive material provided on one surface of a transparent substrate. The first electrode portion and the second electrode portion are arranged in the outer edge portion of the windshield so as to face each other in a vertical direction of the vehicle, and are electrically connected to the transparent conductive film. The third electrode portion and the fourth electrode portion are arranged to face each other in a direction intersecting the direction in which the first electrode portion and the second electrode portion face each other in the outer edge portion of the windshield, and are electrically connected to the transparent conductive film. The control device can execute a plurality of energization modes for energizing the transparent conductive film by setting the first to fourth electrode portions to a high potential, a low potential, or a non-energizing state. In a first mode among the plurality of energization modes, one of the first electrode portion and the second electrode portion is set to a high potential and the other is set to a low potential, or one of the third electrode portion and the fourth electrode portion is set to a high potential and the other is set to a low potential so as to energize the transparent conductive film. In a second mode among the plurality of energization modes, one of the first electrode portion and the second electrode portion is set to a high potential and one of the third electrode portion and the fourth electrode portion is set to a low potential, or one of the first electrode portion and the second electrode portion is set to a low potential and one of the third electrode portion and the fourth electrode portion is set to a high potential so as to energize the transparent conductive film.

According to this configuration, in the first mode, it is possible to heat the entire windshield and remove fogging from the entire windshield or de-icing in winter. In addition, in the second mode, it is possible to prevent window fogging by mainly heating the corner portions of the windshield where window fogging is likely to occur. Therefore, this heater device uses the second mode to prevent window fogging, and can reduce power consumption.

By the way, in general, a vehicle is equipped with an air conditioner that air-conditions the interior of the vehicle. The air conditioner introduces outside air and performs a dehumidifying operation mainly in winter to prevent window fogging. In such a vehicle, by operating the heater device in the second mode to prevent the windshield from fogging up, in the air conditioner, it is possible to increase a circulation rate of the air in the vehicle interior and reduce the amount of outside air introduced. Therefore, this heater device can reduce the power consumed by the air conditioner for heating the outside air and the power consumed for the dehumidification operation.

Furthermore, by preventing the windshield from fogging up with the heater device, it is possible to reduce the amount of air blown from the defroster air outlet in the air conditioner, or to stop air blowing from a defroster air outlet. When hot air is blown out from the defroster air outlet, the air in the upper part of the passenger compartment may be warmed. In addition, when part of the air blown out from the defroster air outlet hits the face of the passenger, the passenger may feel annoyed. On the other hand, by reducing or stopping the amount of air blowing from the defroster air outlet while using this heater device, since the temperature rise of the air in the upper part of the passenger compartment is suppressed, it is possible to improve the comfort in the passenger compartment due to the passenger's cold feet and the like.

According to another aspect of the present disclosure, a heater device for heating a windshield of a vehicle includes a transparent conductive film, a lower electrode portion, a right electrode portion, a left electrode portion, and a control device. The transparent conductive film is arranged in the light-transmitting region of the windshield, and has a conductive material provided on one surface of a transparent substrate. The lower electrode portion is arranged at a vehicle lower portion of the outer edge portion of the windshield, and is electrically connected to the transparent conductive film. The right electrode portion is arranged on the vehicle right side portion of the outer edge portion of the windshield, and is electrically connected to the transparent conductive film. The left electrode portion is arranged on the vehicle left side portion of the outer edge portion of the windshield, and is electrically connected to the transparent conductive film. The control device can execute a plurality of energization modes for energizing the transparent conductive film by setting the lower electrode portion, the right electrode portion and the left electrode portion to a high potential, a low potential, or a non-energizing state. Among the plurality of energization modes, the first mode is a mode in which one of the right electrode portion and the left electrode portion is set at a high potential and the other is set at a low potential to energize the transparent conductive film. In the second mode among the plurality of energization modes, at least one of the right electrode portion and the left electrode portion is set at a high potential and the lower electrode portion is set at a low potential, or at least one of the right electrode portion and the left electrode portion is set at a low potential and the lower electrode portion is set at a high potential so as to energize the transparent conductive film.

According to this configuration, even when the electrode portions are provided on three sides of the windshield as in another aspect of the present disclosure, the same effects as those described in the one aspect of the present disclosure can be achieved.

Hereinafter, embodiments of the present disclosure will be described with reference to the drawings. In the following embodiments, the same or equivalent parts are denoted by the same reference numerals as each other, and explanations will be provided to the same reference numerals. The drawings referred to in the description of each embodiment describe three-dimensional coordinates indicating each direction of the vehicle in a state where the heater device is provided on the windshield of the vehicle.

### First Embodiment

A first embodiment will be described with reference to the drawings. A heater device 1 of the first embodiment heats a front windshield of the vehicle (hereinafter simply referred to as the “windshield 2”), and is capable of de-icing in winter or removing window fog.

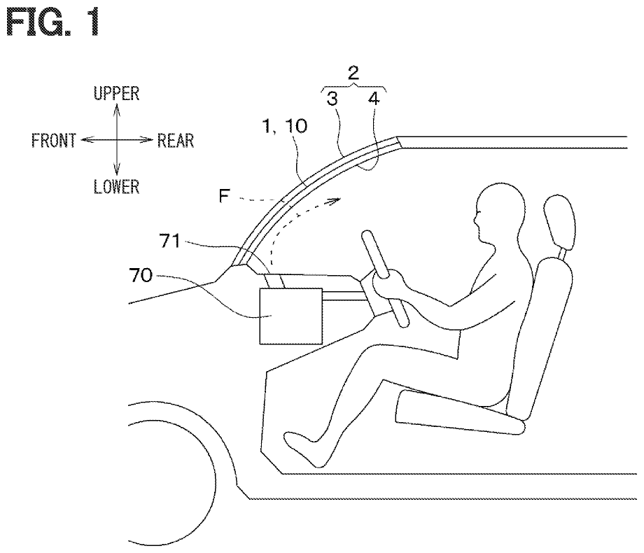

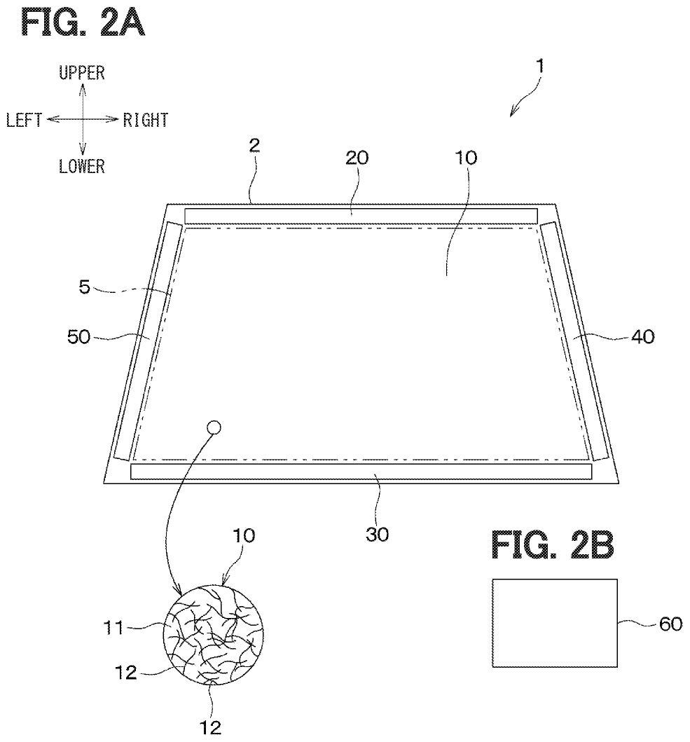

As shown in FIGS. 1 and 2, the heater device 1 includes a transparent conductive film 10, an upper electrode portion 20, a lower electrode portion 30, a right electrode portion 40, a left electrode portion 50, a control device 60, and the like. In the description of the first to third embodiments, the upper electrode portion 20 corresponds to the “first electrode portion”. The lower electrode portion 30 corresponds to the “second electrode portion”. The right electrode portion 40 corresponds to the “third electrode portion”. The left electrode portion 50 corresponds to the “fourth electrode portion”. The transparent conductive film 10, the upper electrode portion 20, the lower electrode portion 30, the right electrode portion 40 and the left electrode portion 50 provided in the heater device 1 are provided in a state of being sandwiched between a vehicle-exterior glass 3 and a vehicle-interior glass 4 that constitute a laminated glass that constitutes the windshield 2.

The transparent conductive film 10 is, for example, a thin film in which a conductive material 12 is provided on one surface of a thin transparent substrate 11. As the transparent substrate 11, it is possible to use, for example, a resin material such as PET (that is, polyethylene terephthalate) or an inorganic material such as quartz glass. As the conductive material 12, for example, CNTs (ie, carbon nanotubes), AgNWs (ie, silver nanowires), PEDOT (ie, polyethylenedioxythiophene), metal thin films, or the like can be used. The transparent conductive film 10 is provided on the light-transmitting region of the windshield 2 (that is, the entire surface of the windshield 2).

The upper electrode portion 20, the lower electrode portion 30, the right electrode portion 40, and the left electrode portion 50 are made of thin plates of metal such as copper, or made of sintered or hardened metal paste. The upper electrode portion 20, the lower electrode portion 30, the right electrode portion 40, and the left electrode portion 50 are electrically connected to the transparent conductive film 10.

The upper electrode portion 20 is arranged at a vehicle upper side portion of an outer edge portion of the windshield 2 and extends in a left-right direction of the vehicle along the outer edge portion of the windshield 2. The lower electrode portion 30 is arranged at a vehicle lower side portion of the outer edge portion of the windshield 2 and extends in the vehicle left-right direction along the outer edge portion of the windshield 2. The upper electrode portion 20 and the lower electrode portion 30 are arranged on the outer edge portion of the windshield 2 so as to face each other in a vertical direction of the vehicle.

The right electrode portion 40 is arranged on the right side of the vehicle at the outer edge portion of the windshield 2 and extends along the outer edge portion of the windshield 2 in the vertical direction and the longitudinal direction of the vehicle. The left electrode portion 50 is arranged on the left side of the vehicle at the outer edge portion of the windshield 2, and extends in the vertical direction and the longitudinal direction of the vehicle along the outer edge portion of the windshield 2 as viewed from the inside of the passenger compartment. The right electrode portion 40 and the left electrode portion 50 are arranged to face each other in the left-right direction of the vehicle (that is, the direction crossing the direction in which the upper electrode portion 20 and the lower electrode portion 30 face each other) at the outer edge portion of the windshield 2.

In this specification, the outer edge portion of the windshield 2 refers to a range having a predetermined width (for example, about 10 to 100 mm) from the outer circumference of the windshield 2 to the inside. That is, the upper electrode portion 20, the lower electrode portion 30, the right electrode portion 40, and the left electrode portion 50 are provided in the range of the outer edge portion. In FIG. 2A, an inner boundary of the outer edge portion of the windshield 2 is indicated by a chain double-dashed line 5, but the boundary is conceptual and not actually divided. Generally, the outer edge portion of the windshield 2 is sometimes painted black.

The upper electrode portion 20, the lower electrode portion 30, the right electrode portion 40, and the left electrode portion 50 are each switched to a high potential, a low potential, or a non-energized state by energization control by the control device 60. The control device 60 is a controller composed of a microcomputer including memory such as a processor, ROM and RAM, and its peripheral circuits. The memory of the control device 60 is composed of a non-transitional physical storage medium. The control device 60 sets the upper electrode portion 20, the lower electrode portion 30, the right electrode portion 40, and the left electrode portion 50 to a high potential, a low potential, or a non-conducting state, and is configured to execute a plurality of energizing modes in which the transparent conductive film 10 is energized.

In this specification, setting the electrode portion to a high potential means that the positive electrode of the battery (not shown) mounted on the vehicle and the electrode are electrically connected via wiring or the like, and power is supplied from the battery to the electrode. Further, setting the electrode portion to a low potential means that the negative electrode of the battery and the electrode portion are electrically connected via wiring, the vehicle body, etc., and the electrode portion is set to the ground potential. Further, setting the electrode portion in a non-energized state means that the electrical connection between the battery and the electrode portion is cut off.

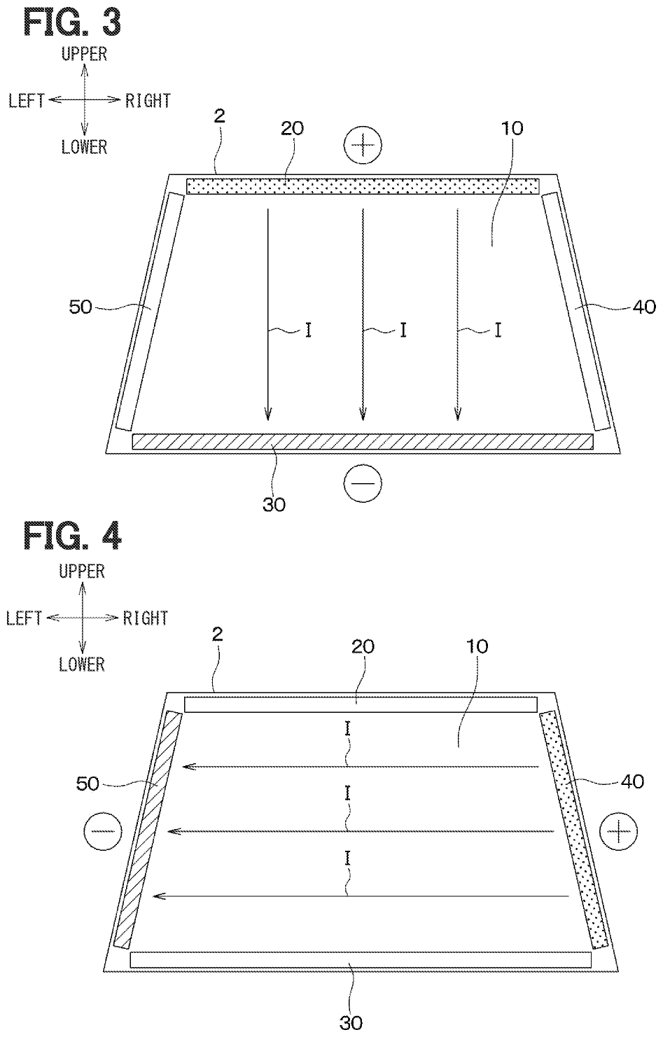

A plurality of energization modes executed by the control device 60 will be described below with reference to FIGS. 3 to 6.

First, a first mode among the plurality of energization modes will be described. The first mode is a mode for heating the entire windshield 2. FIG. 3 shows an example of the first mode. In the first mode, the control device 60 sets the upper electrode portion 20 to a high potential, sets the lower electrode portion 30 to a low potential, and energizes the transparent conductive film 10.

In FIG. 3, an arrow I schematically indicates a direction in which the current flows through the transparent conductive film 10. In addition, in order to clearly show the electrode portion having a high potential, it is indicated by dot hatching although it is not a cross section. In addition, in order to clearly show the electrode portion having a low potential, it is indicated by diagonal hatching although it is not a cross section. The same applies to the drawings referred to in the later description. As indicated by arrow I in FIG. 3, in the first mode, the current flows substantially uniformly throughout the transparent conductive film 10. Therefore, it is possible to heat the entire windshield 2 in the first mode.

Although not shown, in the first mode, the control device 60 may set the upper electrode section 20 to a low potential and the lower electrode section 30 to a high potential to energize the transparent conductive film 10. In that case, the current flows in the direction opposite to the direction of arrow I shown in FIG. 3.

Also, FIG. 4 shows another example of the first mode. As shown in FIG. 4, in the first mode, the control device 60 may set the right electrode section 40 to a high potential and the left electrode section 50 to a low potential to energize the transparent conductive film 10. This configuration also causes the current to flow substantially uniformly through the entire transparent conductive film 10.

Although not shown, in the first mode, the control device 60 may set the right electrode section 40 to a low potential and the left electrode section 50 to a high potential to energize the transparent conductive film 10. In that case, the current flows in the direction opposite to the direction of arrow I shown in FIG. 4.

By executing the first mode, the heater device 1 can heat the entire windshield 2 to remove fogging from the entire windshield 2 or de-icing in winter.

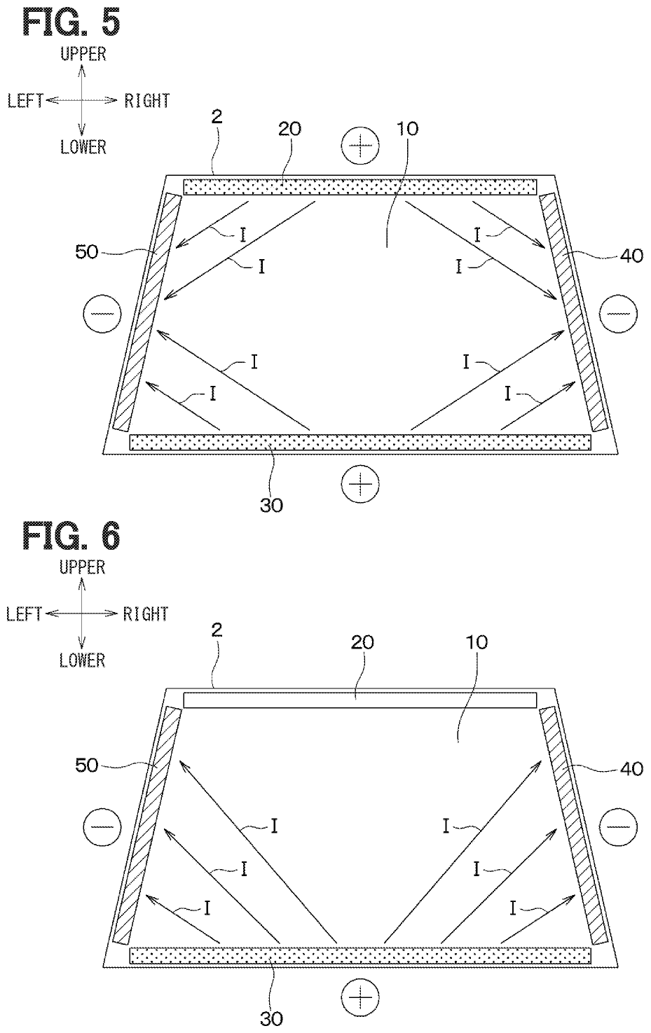

Next, the second mode among the plurality of energization modes will be described. The second mode is a mode that mainly heats the corner portions of the windshield 2 where window fogging is likely to occur. The corner portion of the windshield 2 refers to a predetermined area near a corner portion of the light-transmitting region of the windshield 2. FIG. 5 shows an example of the second mode. As shown in FIG. 5, in the second mode, the control device 60 sets the upper electrode portion 20 and the lower electrode portion 30 to a high potential, sets the right electrode portion 40 and the left electrode portion 50 to a low potential, and energizes the transparent conductive film 10. As a result, in the second mode, a large amount of current flows in the corner portions of the transparent conductive film 10, as indicated by arrow I in FIG. 5. This is because the closer the distance between the electrode portions via the transparent conductive film 10 is, the smaller the electrical resistance therebetween becomes, and the more easily the current flows. Therefore, in the second mode, it is possible to mainly heat the corner portions of the windshield 2 where window fogging is likely to occur.

Although not shown, in the second mode, the control device 60 may set the upper electrode portion 20 and the lower electrode portion 30 to a low potential, set the right electrode portion 40 and the left electrode portion 50 to a high potential, and energize the transparent conductive film 10. In that case, the current flows in the direction opposite to the direction of arrow I shown in FIG. 5.

Also, FIG. 6 shows another example of the second mode. As shown in FIG. 6, in the second mode, the control device 60 sets the upper electrode portion 20 to a non-energized state, sets the lower electrode portion 30 to a high potential, sets the right electrode portion 40 and the left electrode portion 50 to a low potential, and energizes the transparent conductive film 10. As a result, as indicated by arrow I in FIG. 6, a large amount of current flows through the corner portion of the transparent conductive film 10 on the lower side of the vehicle. Therefore, in the second mode, it is possible to mainly heat the corner portion of the windshield 2 on the lower side of the vehicle where window fogging is most likely to occur.

Although not shown, in the second mode, the control device 60 sets the upper electrode portion 20 to a non-energized state, sets the lower electrode portion 30 to a low potential, sets the right electrode portion 40 and the left electrode portion 50 to a high potential, and energizes the transparent conductive film 10. In that case, the current flows in the direction opposite to the direction of arrow I shown in FIG. 6.

By executing the second mode, the heater device 1 mainly heats the corner portion of the windshield 2 where window fogging is likely to occur, and can prevent window fogging.

The heater device 1 of the first embodiment described above has the following effects.

(1) In the first mode of the first embodiment, as shown in FIGS. 3 and 4, the heater device 1 sets one of the upper electrode portion 20 and the lower electrode portion 30 to a high potential and sets the other to a low potential. Alternatively, the heater device 1 sets one of the right electrode portion 40 and the left electrode portion 50 to a high potential and sets the other to a low potential. According to the first mode of the heater device 1, it is possible to heat the entire windshield and remove fogging from the entire windshield or de-icing in winter.

In addition, in the second mode, the heater device 1 sets at least one of the upper electrode portion 20 and the lower electrode portion 30 to a high potential, and sets at least one of the right electrode portion 40 and the left electrode portion 50 to a high potential, as shown in FIGS. 5 and 6. Alternatively, in the second mode, the heater device 1 sets at least one of the upper electrode portion 20 and the lower electrode portion 30 to a low potential, and sets at least one of the right electrode portion 40 and the left electrode portion 50 to a high potential. According to the second mode of the heater device 1, it is possible to prevent window fogging by mainly heating the corner portions of the windshield 2 where window fogging is likely to occur. Therefore, this heater device 1 uses the second mode to prevent window fogging, and can reduce power consumption.

(2) As shown in FIG. 1, the vehicle in which the heater device 1 of the first embodiment is mounted also has the air conditioner 70 for air-conditioning the interior of the vehicle. The air conditioner 70 can introduce outside air and dehumidify mainly in winter to prevent window fogging. In such a vehicle, by operating the heater device 1 in the second mode to prevent fogging of the windshield 2, the air conditioner 70 increases the circulation rate of air in the vehicle interior, and the amount of outside air introduced can be reduced. Therefore, this heater device 1 can reduce the power consumed by the air conditioner 70 for heating the outside air and the power consumed for the dehumidification operation.

(3) Furthermore, by preventing the windshield from fogging up with the heater device 1 of the first embodiment, it is possible to reduce the amount of air blown from the defroster air outlet 71 in the air conditioner 70, or to stop air blowing from a defroster air outlet 71. In addition, in FIG. 1, the dashed line F indicates the wind blown out from the defroster air outlet 71. When hot air is blown out from the defroster air outlet 71, the air in the upper part of the passenger compartment may be warmed. In addition, when part of the air blown out from the defroster air outlet 71 hits the face of the passenger, the passenger may feel annoyed. On the other hand, in the first embodiment, by reducing or stopping the amount of air blowing from the defroster air outlet 71, since the temperature rise of the air in the upper part of the passenger compartment is suppressed, it is possible to improve the comfort in the passenger compartment due to the passenger's cold feet and the like.

### Second Embodiment

A second embodiment will be described. In the second embodiment, the configuration of the electrode portions is changed from that of the first embodiment, and the remaining configurations are the same as those of the first embodiment, and therefore, only parts different from the first embodiment will be described.

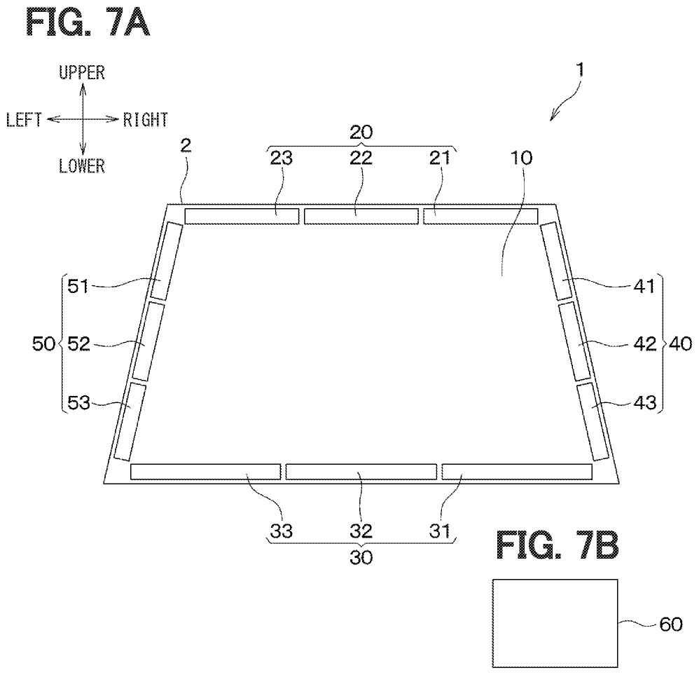

As shown in FIG. 7A, in the second embodiment, each of the upper electrode portion 20, the lower electrode portion 30, the right electrode portion 40, and the left electrode portion 50 is composed of three divided electrodes. The plurality of segmented electrodes are provided so as to line up in the direction in which the outer edge portion of the portion of the windshield 2 where the electrode portion is arranged extends. The number of the plurality of divided electrodes forming the upper electrode portion 20, the lower electrode portion 30, the right electrode portion 40, and the left electrode portion 50 is not limited to three, and may be two or four or more. At least one electrode portion of the upper electrode portion 20, the lower electrode portion 30, the right electrode portion 40, and the left electrode portion 50 may be composed of a plurality of divided electrodes.

In the following description, the three divided electrodes forming the upper electrode portion 20 are referred to as an upper first electrode 21, an upper second electrode 22, and an upper third electrode 23 in order from the right side of the vehicle. The three divided electrodes forming the lower electrode portion 30 are referred to as a lower first electrode 31, a lower second electrode 32, and a lower third electrode 33 in order from the right side of the vehicle. The three divided electrodes forming the right electrode portion 40 are referred to as a right first electrode 41, a right second electrode 42, and a right third electrode 43 in order from the upper side of the vehicle. The three divided electrodes forming the left electrode portion 50 are referred to as a left first electrode 51, a left second electrode 52, and a left third electrode 53 in order from the upper side of the vehicle.

The divided electrodes constituting the upper electrode portion 20, the lower electrode portion 30, the right electrode portion 40, and the left electrode portion 50 are each switched to a high potential, a low potential, or a non-energized state by energization control by the control device 60. The control device 60 executes a mode in which the plurality of divided electrodes constituting the upper electrode portion 20, the lower electrode portion 30, the right electrode portion 40, and the left electrode portion 50 are simultaneously energized, and a mode in which a part of the plurality of divided electrodes is energized.

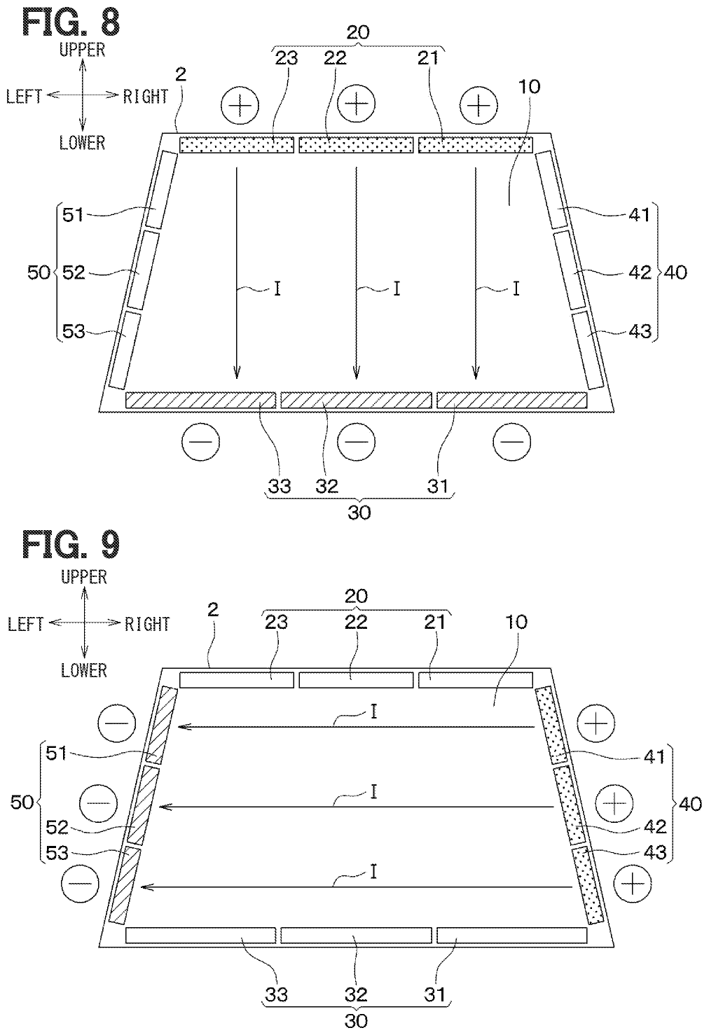

A plurality of energization modes executed by the control device 60 of the second embodiment will be described below with reference to FIGS. 8 to 12.

First, a first mode among the plurality of energization modes will be described. A first mode of the second embodiment is a mode in which a plurality of divided electrodes forming the upper electrode portion 20 and the lower electrode portion 30 are simultaneously energized. The first mode of the second embodiment is also a mode for heating the entire windshield 2, like the first mode described in the first embodiment. FIG. 8 shows an example of the first mode. In the first mode, the control device 60 sets all the divided electrodes forming the upper electrode portion 20 to a high potential, sets all the divided electrodes forming the lower electrode portion 30 to a low potential, and energizes the transparent conductive film 10. As indicated by arrow I in FIG. 8, in the first mode, the current flows substantially uniformly throughout the transparent conductive film 10. Therefore, it is possible to heat the entire windshield 2 in the first mode.

Although illustration is omitted, in the first mode, the control device 60 sets all the divided electrodes forming the upper electrode portion 20 to a low potential, sets all the divided electrodes forming the lower electrode portion 30 to a high potential, and energizes the transparent conductive film 10. In that case, the current flows in the direction opposite to the direction of arrow I shown in FIG. 8.

Also, FIG. 9 shows another example of the first mode of the second embodiment. As shown in FIG. 9, in the first mode, the control device 60 sets all the divided electrodes forming the right electrode portion 40 to a high potential, sets all the divided electrodes forming the left electrode portion 50 to a low potential, and energizes the transparent conductive film 10. This configuration also causes the current to flow substantially uniformly through the entire transparent conductive film 10.

Although illustration is omitted, in the first mode, the control device 60 sets all the divided electrodes forming the right electrode portion 40 to a low potential, sets all the divided electrodes forming the left electrode portion 50 to a high potential, and energizes the transparent conductive film 10. In that case, the current flows in the direction opposite to the direction of arrow I shown in FIG. 9.

By executing the first mode, the heater device 1 can heat the entire windshield 2 to remove fogging from the entire windshield 2 or de-icing in winter.

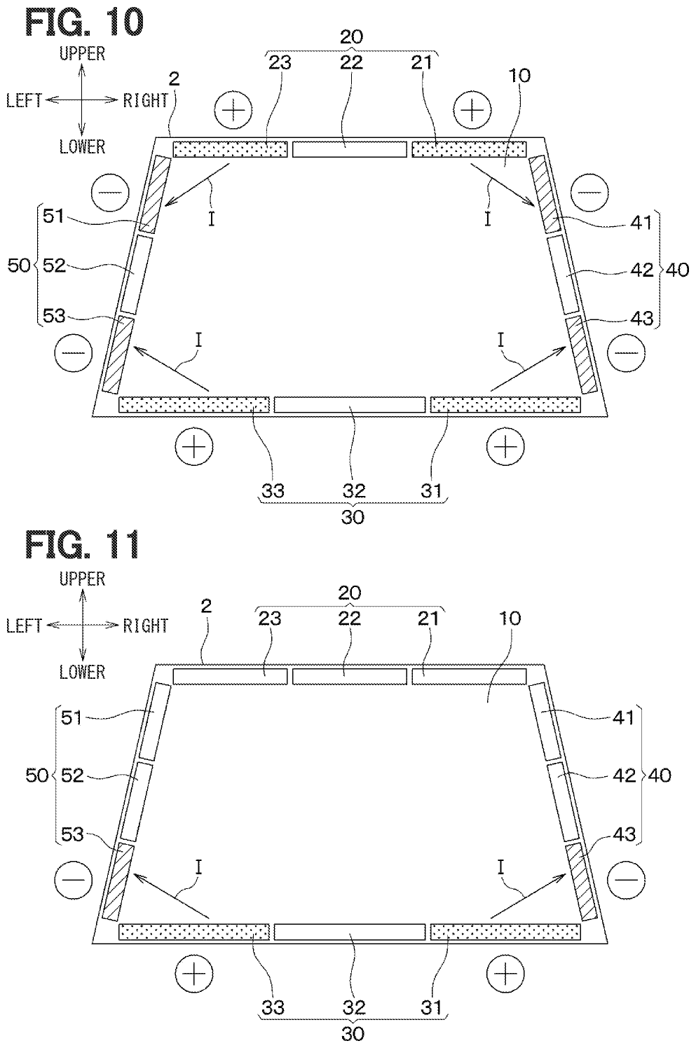

Next, a third mode among the plurality of energization modes executed by the control device 60 of the second embodiment will be described. The third mode of the second embodiment is a mode in which current is supplied to some of the plurality of divided electrodes that constitute the upper electrode portion 20, the lower electrode portion 30, the right electrode portion 40, and the left electrode portion 50. The third mode of the second embodiment is a modification of the second mode described in the first embodiment, and is a mode that mainly heats the corner portions of the windshield 2 where window fogging tends to occur. FIG. 10 shows an example of the third mode. As shown in FIG. 10, in the third mode, the control device 60 sets one of the divided electrodes adjacent to each other across the corner portion of the windshield 2 to a high potential, and sets the other to a low potential. The divided electrodes constitute the upper electrode portion 20, the lower electrode portion 30, the right electrode portion 40, and the left electrode portion 50. Specifically, in FIG. 10, the control device 60 sets the upper first electrode 21, the upper third electrode 23, the lower first electrode 31, and the lower third electrode 33 to a high potential, sets the right first electrode 41, the right third electrode 43, the left first electrode 51 and the left third electrode 53 to a low potential, and energizes the transparent conductive film 10. The control device 60 sets the other divided electrodes to a non-energized state. As a result, as indicated by arrow I in FIG. 10, a large amount of current flows in the corner portions of the transparent conductive film 10 in the third mode. This is because the closer the distance between the divided electrodes via the transparent conductive film 10 is, the smaller the electrical resistance therebetween becomes, and the more easily the current flows. Therefore, in the third mode, it is possible to mainly heat the corner portions of the windshield 2 where window fogging is likely to occur.

Although not shown, the control device 60 may energize in the third mode as follows. Specifically, the control device 60 sets the upper first electrode 21, the upper third electrode 23, the lower first electrode 31, and the lower third electrode 33 to a low potential, sets the right first electrode 41, the right third electrode 43, the left first electrode 51 and the left third electrode 53 to a high potential, and energizes the transparent conductive film 10. In that case, the current flows in the direction opposite to the direction of arrow I shown in FIG. 10.

Also, FIG. 11 shows another example of the third mode of the second embodiment. As shown in FIG. 11, in the third mode, the control device 60 sets the lower first electrode 31 and the lower third electrode 33 to a high potential, sets the right third electrode 43 and the left third electrode 53 to a low potential, and energizes the transparent conductive film 10. The control device 60 sets the other divided electrodes to a non-energized state. As a result, as indicated by arrow I in FIG. 11, a large amount of current flows through the corner portions of the transparent conductive film 10 on the lower side of the vehicle. Therefore, in the third mode, it is possible to mainly heat the corner portions of the windshield 2 on the lower side of the vehicle where window fogging is most likely to occur.

Although illustration is omitted, in the third mode of the second embodiment, the control device 60 sets the lower first electrode 31 and the lower third electrode 33 to a low potential, sets the right third electrode 43 and the left third electrode 53 to a low potential, and energizes the transparent conductive film 10. In that case, the current flows in the direction opposite to the direction of arrow I shown in FIG. 11. By executing the third mode, the heater device 1 mainly heats the corner portion of the windshield 2 where window fogging is likely to occur, and can prevent window fogging.

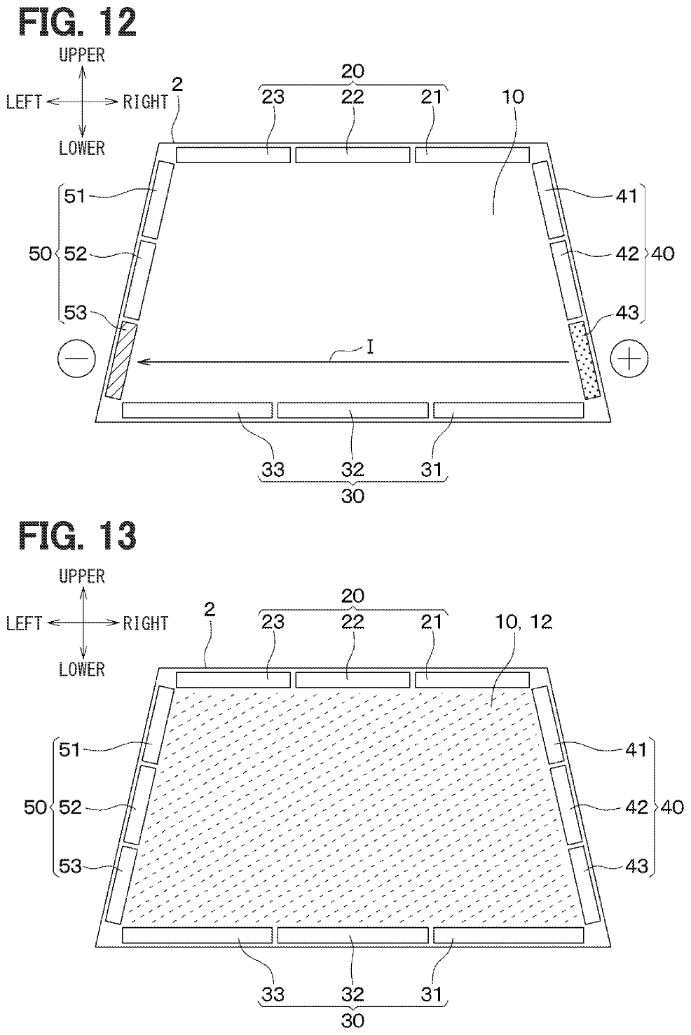

Next, a fourth mode among the plurality of energization modes executed by the control device 60 of the second embodiment will be described. The fourth mode of the second embodiment is a mode that heats the area below the vehicle in the windshield 2, which is an effective area for securing the field of view for the driver's eye point (i.e. position at driver's eye level). FIG. 12 shows an example of the fourth mode. As shown in FIG. 12, in the fourth mode, the control device 60 sets the right third electrode 43 to a high potential and the left third electrode 53 to a low potential to energize the transparent conductive film 10. The control device 60 sets the other divided electrodes to a non-energized state. As a result, as indicated by arrow I in FIG. 12, in the fourth mode, a large amount of current flows through the region of the transparent conductive film 10 below the vehicle. Therefore, it is possible to mainly heat the region of the windshield 2 below the vehicle in the fourth mode.

Although not shown, in the fourth mode, the control device 60 may set the right third electrode 43 to a low potential and the left third electrode 53 to a high potential to energize the transparent conductive film 10. In that case, the current flows in the direction opposite to the direction of arrow I shown in FIG. 12.

The heater device 1 of the second embodiment described above has the following effects.

(1) In the heater device 1 of the second embodiment, the upper electrode portion 20, the lower electrode portion 30, the right electrode portion 40, and the left electrode portion 50 are each composed of a plurality of divided electrodes. The control device 60 can execute a mode in which a plurality of divided electrodes are energized simultaneously and a mode in which a portion of the plurality of divided electrodes are energized. According to this configuration, it becomes possible to heat only the portion of the windshield 2 that needs to be heated, and power consumption can be further reduced.

(2) In the third mode, the heater device 1 of the second embodiment energizes as illustrated in FIGS. 10 and 11. That is, in the third mode, the control device 60 sets one of the divided electrodes adjacent to each other across the corner portion of the windshield 2 to a high potential, and sets the other to a low potential. The divided electrodes constitute the upper electrode portion 20, the lower electrode portion 30, the right electrode portion 40, and the left electrode portion 50. According to this configuration, among the divided electrodes constituting the upper electrode portion 20, the lower electrode portion 30, the right electrode portion 40, and the left electrode portion 50, only the divided electrodes necessary for preventing window fogging at the corner portion of the windshield 2 are used. Therefore, power consumption can be reduced.

(3) In the fourth mode, as illustrated in FIG. 12, the heater device 1 of the second embodiment sets one of the divided electrodes that constitute the right electrode portion 40 and the left electrode portion 50, which are arranged on the lower side of the vehicle, to a high potential, and sets the other at a low potential. According to this configuration, it is possible to prevent window fogging in the area on the lower side of the vehicle in the windshield 2, which is an effective area for securing the field of view for the driver's eye point.

Also in the heater device 1 of the second embodiment, the same effect as the first embodiment can be obtained from the same configuration as the first embodiment. That is, the heater device 1 of the second embodiment can also implement the first mode and the second mode described in the first embodiment.

### Third Embodiment

A third embodiment will be described. In the third embodiment, the orientation of the conductive material 12 constituting the transparent conductive film 10 is changed from that of the first embodiment and the like. Thus, only the parts different from the embodiment and the like will be described.

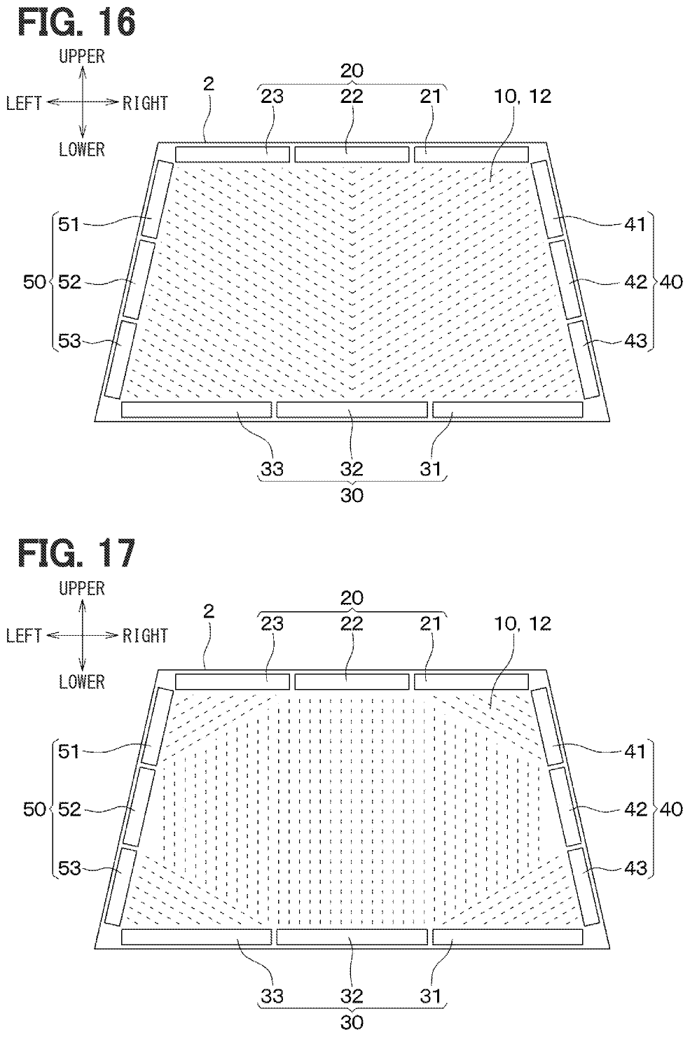

As shown in FIG. 13, in the third embodiment, the conductive material 12 forming the transparent conductive film 10 is aligned in a direction oblique to the vertical direction of the vehicle and the horizontal direction of the vehicle. In FIG. 13, a direction in which the conductive material 12 is oriented is indicated by the direction in which a plurality of dashed lines extend. This also applies to FIGS. 16 and 17 referred to in modified examples 1 and 2 of the third embodiment, which will be described later.

Specifically, in FIG. 13, the orientation of the conductive material 12 is aligned so as to be inclined from the upper right side of the windshield 2 to the lower left side thereof. Alternatively, it can be said that the orientation of the conductive material 12 is aligned so as to be inclined from the lower left side of the windshield 2 to the upper right side thereof. It is possible to effectively reduce the electric resistance value in the direction (hereinafter referred to as a “orientation direction”) in which the conductive material 12 is oriented in the transparent conductive film 10. By lowering the electrical resistance value in the orientation direction of the conductive material 12, the amount of current in the orientation direction of the conductive material 12 increases, and accordingly the heat generation amount also increases. Therefore, in the configuration shown in FIG. 13, the amount of heat generated at the lower right corner portion and the upper left corner portion of the windshield 2 can be increased.

Although illustration is omitted, the orientation of the conductive material 12 may be aligned so as to be inclined from the upper left side of the windshield 2 to the lower right side thereof. Alternatively, it can be said that the orientation of the conductive material 12 may be aligned so as to be inclined from the lower right side of the windshield 2 to the upper left side thereof. In such a configuration, the amount of heat generated at the lower left corner portion and the upper right corner portion of the windshield 2 can be increased.

In the third embodiment described above, the conductive material 12 forming the transparent conductive film 10 is oriented in a direction oblique to the vertical and horizontal directions of the vehicle. Therefore, the heater device 1 of the third embodiment reduces the electric resistance value of the corner portion of the windshield 2 in the transparent conductive film 10 and increases the amount of heat generation, thereby preventing fogging of the window at the corner portions of the windshield 2.

In this specification, the term “orientation is aligned” means that the degree of orientation of the conductive material 12 is 15% or more, more preferably 24% or more. As a result, the electric resistance of the transparent conductive film 10 can be lowered, and the effect of preventing window fogging at the corner portions of the windshield 2 can be enhanced.

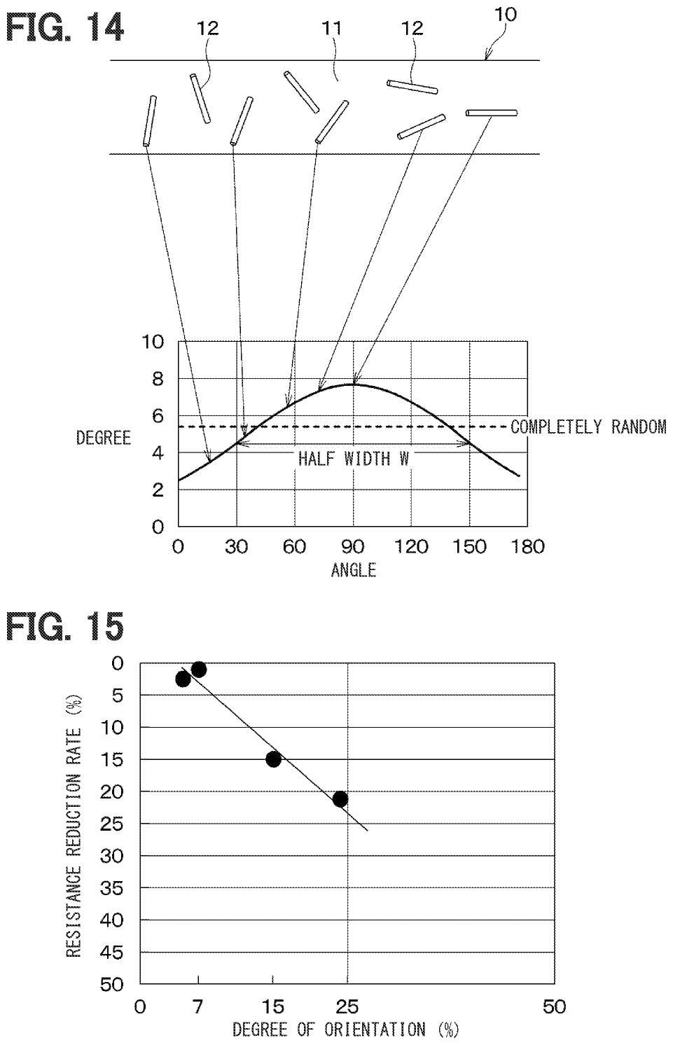

Here, a method for calculating the degree of orientation of the conductive material 12 will be described with reference to FIG. 14.

To calculate the degree of orientation of the conductive material 12, the transparent conductive film 10 is observed using a scanning electron microscope and image analysis is performed. The upper diagram of FIG. 14 schematically shows CNTs (that is, carbon nanotubes) as an example of the conductive material 12. Specifically, an image obtained by a scanning electron microscope is binarized and Fourier-transformed to create a power spectrum graph as shown in the lower part of FIG. 14. Then, the degree of orientation is calculated from the following (Equation 1) using the half width W of the graph.

Degree of orientation=(180−W)/180×100 Equation 1

Next, the relationship between the degree of orientation of CNTs as an example of the conductive material 12 forming the transparent conductive film 10 and the electrical resistance reduction rate of the transparent conductive film 10 will be described with reference to FIG. 15. FIG. 15 is a graph showing the results of experiments conducted by the inventors.

As shown in FIG. 15, by increasing the degree of orientation from about 7% (that is, completely random, non-oriented) to about 24%, the resistance reduction rate of the transparent conductive film 10 becomes 20% or more. Therefore, the transparent conductive film 10 can lower the electric resistance value by increasing the degree of orientation of the conductive material 12.

(First Modification of Third Embodiment)

A first modification of the third embodiment will be described. In this first modification, the orientation of the conductive material 12 constituting the transparent conductive film 10 is changed with respect to the third embodiment.

As shown in FIG. 16, in the first modification of the third embodiment, the orientation of the conductive material 12 constituting the transparent conductive film 10 differs between the right half area from the center of the windshield 2 and the left half area from the center thereof. Specifically, the orientation of the conductive material 12 is aligned so as to be inclined from the upper right side to the lower left side of the windshield 2 in the right half area from the center of the windshield 2. Alternatively, it can be said that the orientation of the conductive material 12 is aligned so as to be inclined from the lower left side to the upper right side of the windshield 2 in the right half area from the center of the windshield 2. In addition, the orientation of the conductive material 12 is aligned so as to incline from the upper left side of the windshield 2 to the lower right side in the left half area of the windshield 2 from the center. Alternatively, it can be said that the orientation of the conductive material 12 is aligned so as to be inclined from the lower right side to the upper left side of the windshield 2 in the left half area from the center of the windshield 2. Thus, in the first Modification of the third embodiment, it is possible to enhance the effect of preventing window fogging at the lower right corner portion and the lower left corner portion of the windshield 2.

(Second Modification of Third Embodiment)

A second modification of the third embodiment will be described. In this second modification, the orientation of the conductive material 12 constituting the transparent conductive film 10 is changed with respect to the third embodiment.

As shown in FIG. 17, in the second Modification of the third embodiment, the orientation of the conductive material 12 forming the transparent conductive film 10 is different between the four corner portions and the central area of the windshield 2. Specifically, the orientation of the conductive material 12 is parallel to the vertical direction of the vehicle in the central area of the windshield 2.

Also, the orientation of the conductive material 12 forming the transparent conductive film 10 is such that, at each corner portion of the windshield 2, the orientation is uniform in the direction connecting one divided electrode and the other divided electrode which are arranged adjacent to each other across the corner portion of the windshield 2. Specifically, the conductive material 12 arranged at the upper right corner portion of the windshield 2 is aligned in the direction connecting the upper first electrode 21 and the right first electrode 41. The conductive material 12 arranged at the upper left corner portion of the windshield 2 is aligned in the direction connecting the upper third electrode 23 and the left first electrode 51. The conductive material 12 arranged at the lower right corner portion of the windshield 2 is aligned in the direction connecting the lower first electrode 31 and the right third electrode 43. The conductive material 12 arranged at the lower left corner portion of the windshield 2 is aligned in the direction connecting the lower third electrode 33 and the left third electrode 53. Thereby, in the second Modification of the third embodiment, the effect which prevents the window fogging of the four corner parts of the windshield 2 can be enhanced.

### Fourth Embodiment

A fourth embodiment will be described. In the fourth embodiment, a part of the configuration of the electrode portion is changed with respect to the first embodiment, and the other parts are similar to that in the first embodiment, so only the difference from the first embodiment will be described.

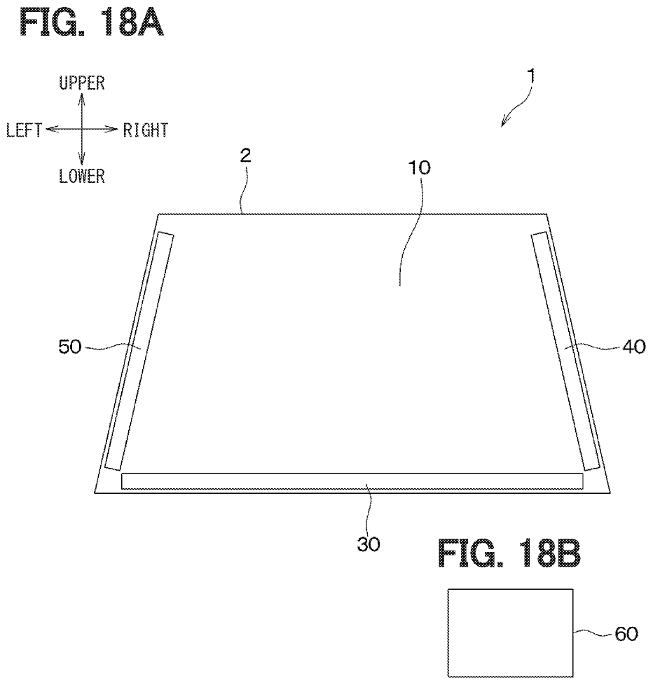

As shown in FIG. 18A, the electrode portions provided in the heater device 1 of the fourth embodiment are provided on the windshield 2 on the right side, the left side, and the bottom side of the vehicle. Specifically, the heater device 1 of the fourth embodiment includes a transparent conductive film 10, a lower electrode portion 30, a right electrode portion 40, a left electrode portion 50, a control device 60, and the like. The upper electrode portion 20 is not provided. The control device 60 sets the lower electrode portion 30, the right electrode portion 40, and the left electrode portion 50 to a high potential, a low potential, or a non-conducting state, and is configured to execute a plurality of energizing modes in which the transparent conductive film 10 is energized.

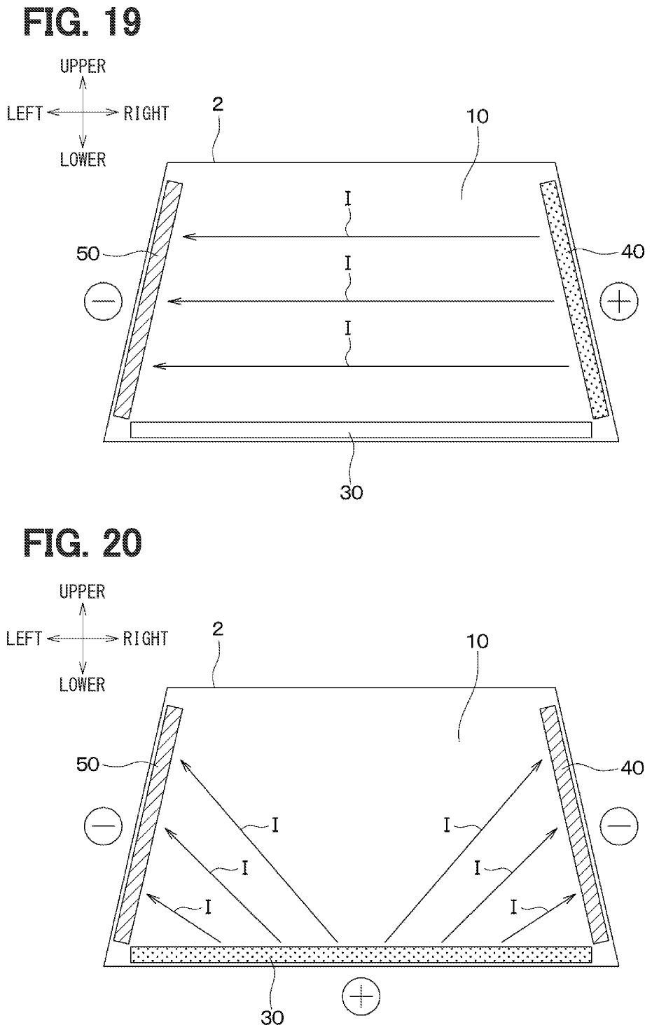

A plurality of energization modes executed by the control device 60 of the fourth embodiment will be described below with reference to FIGS. 19 to 20.

First, the first mode among the plurality of energization modes executed by the control device 60 of the fourth embodiment will be described. The first mode is a mode for heating the entire windshield 2. As shown in FIG. 19, in the first mode, the control device 60 sets the right electrode section 40 to a high potential and the left electrode section 50 to a low potential to energize the transparent conductive film 10. As indicated by arrow I in FIG. 19, in the first mode, the current flows substantially uniformly throughout the transparent conductive film 10. Therefore, it is possible to heat the entire windshield 2 in the first mode.

Although not shown, in the first mode, the control device 60 may set the right electrode section 40 to a low potential and the left electrode section 50 to a high potential to energize the transparent conductive film 10. In that case, the current flows in the direction opposite to the direction of arrow I shown in FIG. 19.

By executing the first mode, the heater device 1 can heat the entire windshield 2 to remove fogging from the entire windshield 2 or de-icing in winter.

Next, a second mode among the plurality of energization modes executed by the control device 60 of the fourth embodiment will be described. The second mode is a mode that mainly heats the corner portions of the windshield 2 where window fogging is likely to occur. As shown in FIG. 20, in the second mode, the control device 60 sets the lower electrode portion 30 to a high potential, sets the right electrode portion 40 and the left electrode portion 50 to a low potential, and energizes the transparent conductive film 10. As a result, as indicated by arrow I in FIG. 20, a large amount of current flows in the corner portions of the transparent conductive film 10 in the second mode. This is because the closer the distance between the electrode portions via the transparent conductive film 10 is, the smaller the electrical resistance therebetween becomes, and the more easily the current flows. Therefore, in the second mode, it is possible to mainly heat the corner portion of the windshield 2 on the lower side of the vehicle where window fogging is most likely to occur.

Although not shown, in the second mode, the control device 60 may set the lower electrode portion 30 to a low potential, set the right electrode portion 40 and the left electrode portion 50 to a high potential, and energize the transparent conductive film 10. In that case, the current flows in the direction opposite to the direction of arrow I shown in FIG. 20.

By executing the second mode, the heater device 1 mainly heats the corner portion of the windshield 2 where window fogging is likely to occur, and can prevent window fogging.

Also in the heater device 1 of the fourth embodiment described above, the same effect as the first embodiment can be obtained from the same configuration as the first embodiment.

### Other Embodiments

(1) In each of the above embodiments, the heater device is provided on the front windshield of the vehicle, but the heater device is not limited to this configuration, and may be provided on the side window or the rear window, for example. When the heater device is provided on the side window, the third electrode portion specifically corresponds to “a front electrode portion arranged at the front side portion of the vehicle on the outer edge portion of the side window”. Further, the fourth electrode portion specifically corresponds to “a rear electrode portion arranged at a portion on the rear side of the vehicle in the outer edge portion of the side window”. A side window and a rear window are examples of a windshield.

(2) In the above-described second embodiment, the heater device 1 is explained assuming that the upper electrode portion 20, the lower electrode portion 30, the right electrode portion 40, and the left electrode portion 50 are all composed of divided electrodes. For example, in the heater device 1, at least one of the upper electrode portion 20, the lower electrode portion 30, the right electrode portion 40, and the left electrode portion 50 may be composed of divided electrodes.

(3) In the first and second Modifications of the third embodiment, the areas in which the orientation of the conductive material 12 constituting the transparent conductive film 10 is aligned are divided into 2 to 5 areas. However, the number of areas can be set arbitrarily.

(4) In the first to third embodiments, the heater device 1 has been described as having the upper electrode portion 20, the lower electrode portion 30, the right electrode portion 40, and the left electrode portion 50 as the electrode portions. However, depending on the shape of the windshield 2, other electrode portions may be included.

(5) Also in the heater device 1 of the fourth embodiment, at least one of the lower electrode portion 30, the right electrode portion 40 and the left electrode portion 50 may be composed of divided electrodes.

The present disclosure is not limited to the above-described embodiments, and can be appropriately modified. The above-described embodiments are not independent of each other, and can be appropriately combined together except when the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Further, in each of the above-mentioned embodiments, when referring to the shape, positional relationship, and the like of a component and the like, the component is not limited to the shape, positional relationship, and the like, except for the case where the component is specifically specified, the case where the component is fundamentally limited to a specific shape, positional relationship, and the like.

The control unit and the method thereof described in the present disclosure are realized by a dedicated computer provided by configuring a processor and a memory programmed to execute one or more functions embodied by a computer program. May be done. Alternatively, the control device and the technique according to the present disclosure may be achieved by a dedicated computer provided by constituting a processor with one or more dedicated hardware logic circuits. Alternatively, the control device and the method thereof described in the present disclosure are based on a combination of a processor and a memory programmed to execute one or more functions and a processor configured by one or more hardware logic circuits. It may be realized by one or more configured dedicated computers. The computer programs may be stored, as instructions to be executed by a computer, in a tangible non-transitory computer-readable medium.

What is claimed is:

1. A heater device for heating a windshield of a vehicle, comprising:
a transparent conductive film disposed in a light-transmitting region of the windshield and having a conductive material provided on one surface of a transparent substrate;
a first electrode portion and a second electrode portion arranged opposite to each other in a vertical direction of the vehicle in an outer edge portion of the windshield and electrically connected to the transparent conductive film;
a third electrode portion and a fourth electrode portion arranged opposite to each other in a direction intersecting a direction in which the first electrode portion and the second electrode portion face each other in the outer edge portion of the windshield, and electrically connected to the transparent conductive film; and
a control device configured to execute a plurality of energization modes for energizing the transparent conductive film by setting the first to fourth electrode portions to a high potential, a low potential, or a non-energizing state, wherein
in a first mode among the plurality of energization modes, one of the first electrode portion and the second electrode portion is set to a high potential and the other is set to a low potential, or one of the third electrode portion and the fourth electrode portion is set to a high potential and the other is set to a low potential so as to energize the transparent conductive film, and
in a second mode among the plurality of energization modes, one of the first electrode portion and the second electrode portion is set to a high potential and one of the third electrode portion and the fourth electrode portion is set to a low potential, or one of the first electrode portion and the second electrode portion is set to a low potential and one of the third electrode portion and the fourth electrode portion is set to a high potential so as to energize the transparent conductive film,
the vehicle is equipped with an air conditioner that air-conditions a vehicle interior, and the air conditioner introduces outside air, dehumidifies, and blows air toward the windshield from a defroster outlet provided in the vehicle, and
when the control device executes at least one of the plurality of energization modes that prevents window fogging, the air conditioner increases a circulation rate of the air in the vehicle interior to reduce the amount of outside air introduced, or reduces or stops blowing air from the defroster outlet.

2. The heater device according to claim 1, wherein
at least one of the first to fourth electrode portions is composed of a plurality of divided electrodes arranged in a direction in which an outer edge portion of a portion of the windshield where the electrode portion is arranged extends, and
the control device executes a mode in which the plurality of divided electrodes are energized simultaneously and a mode in which a part of the plurality of divided electrodes are energized.

3. The heater device according to claim 2, wherein
in a third mode among the plurality of energization modes, one of the divided electrodes constituting the first to fourth electrode portions, which are arranged adjacent to each other across the corner portion of the windshield, is set to a high potential, and the other is set to a low potential and the transparent conductive film is energized.

4. The heater device according to claim 2, wherein
in a fourth mode among the plurality of energization modes, one of the divided electrodes arranged on a lower side of the vehicle among the divided electrodes constituting the third electrode portion and the fourth electrode portion is set to a high potential and the other is set to a low potential, and the transparent conductive film is energized.

5. A heater device for heating a windshield of a vehicle, comprising:
a transparent conductive film disposed in a light-transmitting region of the windshield and having a conductive material provided on one surface of a transparent substrate;
a first electrode portion and a second electrode portion arranged opposite to each other in a vertical direction of the vehicle in an outer edge portion of the windshield and electrically connected to the transparent conductive film;
a third electrode portion and a fourth electrode portion arranged opposite to each other in a direction intersecting a direction in which the first electrode portion and the second electrode portion face each other in the outer edge portion of the windshield, and electrically connected to the transparent conductive film; and
a control device configured to execute a plurality of energization modes for energizing the transparent conductive film by setting the first to fourth electrode portions to a high potential, a low potential, or a non-energizing state, wherein
in a first mode among the plurality of energization modes, one of the first electrode portion and the second electrode portion is set to a high potential and the other is set to a low potential, or one of the third electrode portion and the fourth electrode portion is set to a high potential and the other is set to a low potential so as to energize the transparent conductive film,
in a second mode among the plurality of energization modes, one of the first electrode portion and the second electrode portion is set to a high potential and one of the third electrode portion and the fourth electrode portion is set to a low potential, or one of the first electrode portion and the second electrode portion is set to a low potential and one of the third electrode portion and the fourth electrode portion is set to a high potential so as to energize the transparent conductive film,
at least one of the first to fourth electrode portions is composed of a plurality of divided electrodes arranged in a direction in which an outer edge portion of a portion of the windshield where the electrode portion is arranged extends,
the control device executes a mode in which a plurality of divided electrodes are energized simultaneously and a mode in which a portion of the plurality of divided electrodes are energized, and
the conductive material constituting the transparent conductive film is oriented at least in a direction connecting one of the divided electrodes and the other of the divided electrodes, which are arranged adjacent to each other across a corner portion of the windshield.

6. The heater device according to claim 5, wherein
in a third mode among the plurality of energization modes, one of the divided electrodes constituting the first to fourth electrode portions, which are arranged adjacent to each other across the corner portion of the windshield, is set to a high potential, and the other is set to a low potential and the transparent conductive film is energized.

7. The heater device according to claim 5, wherein
in a fourth mode among the plurality of energization modes, one of the divided electrodes arranged on a lower side of the vehicle among the divided electrodes constituting the third electrode portion and the fourth electrode portion is set to a high potential and the other is set to a low potential, and the transparent conductive film is energized.

8. A heater device for heating a windshield of a vehicle, comprising:
a transparent conductive film disposed in a light-transmitting region of the windshield and having a conductive material provided on one surface of a transparent substrate;
a first electrode portion and a second electrode portion arranged opposite to each other in a vertical direction of the vehicle in an outer edge portion of the windshield and electrically connected to the transparent conductive film;
a third electrode portion and a fourth electrode portion arranged opposite to each other in a direction intersecting a direction in which the first electrode portion and the second electrode portion face each other in the outer edge portion of the windshield, and electrically connected to the transparent conductive film; and
a control device configured to execute a plurality of energization modes for energizing the transparent conductive film by setting the first to fourth electrode portions to a high potential, a low potential, or a non-energizing state, wherein
in a first mode among the plurality of energization modes, one of the first electrode portion and the second electrode portion is set to a high potential and the other is set to a low potential, or one of the third electrode portion and the fourth electrode portion is set to a high potential and the other is set to a low potential so as to energize the transparent conductive film,
in a second mode among the plurality of energization modes, one of the first electrode portion and the second electrode portion is set to a high potential and one of the third electrode portion and the fourth electrode portion is set to a low potential, or one of the first electrode portion and the second electrode portion is set to a low potential and one of the third electrode portion and the fourth electrode portion is set to a high potential so as to energize the transparent conductive film, and
the conductive material constituting the transparent conductive film is oriented in a direction oblique to the vertical and horizontal directions of the vehicle.

9. A heater device for heating a windshield of a vehicle, comprising:
a transparent conductive film disposed in a light-transmitting region of the windshield and having a conductive material provided on one surface of a transparent substrate;
a lower electrode portion arranged at a vehicle lower portion of an outer edge portion of the windshield, and electrically connected to the transparent conductive film;
a right electrode portion arranged on the vehicle right side portion of the outer edge portion of the windshield, and electrically connected to the transparent conductive film;
a left electrode portion arranged at a vehicle left side of the outer edge portion of the windshield and electrically connected to the transparent conductive film; and
a control device configured to execute a plurality of energization modes for energizing the transparent conductive film by setting the lower electrode portion, the right electrode portion, and the left electrode portion to a high potential, a low potential, or a non-energizing state, wherein
in a first mode among the plurality of energization modes, one of the right electrode portion and the left electrode portion is set to a high potential and the other is set to a low potential to energize the transparent conductive film,
in a second mode among the plurality of energization modes, at least one of the right electrode portion and the left electrode portion is set to a high potential and the lower electrode portion is set to a low potential, or at least one of the right electrode portion and the left electrode portion is set to a low potential and the lower electrode portion is set to a high potential so as to energize the transparent conductive film,
the vehicle is equipped with an air conditioner that air-conditions a vehicle interior, and the air conditioner introduces outside air, dehumidifies, and blows air toward the windshield from a defroster outlet provided in the vehicle, and
when the control device executes at least one of the plurality of energization modes that prevents window fogging, the air conditioner increases a circulation rate of the air in the vehicle interior to reduce the amount of outside air introduced, or reduces or stops blowing air from the defroster outlet.

10. A heater device for heating a windshield of a vehicle, comprising:
a transparent conductive film disposed in a light-transmitting region of the windshield and having a conductive material provided on one surface of a transparent substrate;
a lower electrode portion arranged at a vehicle lower portion of an outer edge portion of the windshield, and electrically connected to the transparent conductive film;
a right electrode portion arranged on the vehicle right side portion of the outer edge portion of the windshield, and electrically connected to the transparent conductive film;
a left electrode portion arranged at a vehicle left side of the outer edge portion of the windshield and electrically connected to the transparent conductive film; and
a control device configured to execute a plurality of energization modes for energizing the transparent conductive film by setting the lower electrode portion, the right electrode portion, and the left electrode portion to a high potential, a low potential, or a non-energizing state, wherein
in a first mode among the plurality of energization modes, one of the right electrode portion and the left electrode portion is set to a high potential and the other is set to a low potential to energize the transparent conductive film,
in a second mode among the plurality of energization modes, at least one of the right electrode portion and the left electrode portion is set to a high potential and the lower electrode portion is set to a low potential, or at least one of the right electrode portion and the left electrode portion is set to a low potential and the lower electrode portion is set to a high potential so as to energize the transparent conductive film,
at least one of the lower electrode portion, the right electrode portion, and the left electrode portion is composed of a plurality of divided electrodes arranged in a direction in which an outer edge portion of the portion of the windshield where the electrode portion is arranged extends,
the control device executes a mode in which a plurality of divided electrodes are energized simultaneously and a mode in which a portion of the plurality of divided electrodes are energized, and
the conductive material constituting the transparent conductive film is oriented at least in a direction connecting one of the divided electrodes and the other of the divided electrodes, which are arranged adjacent to each other across a corner portion of the windshield.

11. A heater device for heating a windshield of a vehicle, comprising:
a transparent conductive film disposed in a light-transmitting region of the windshield and having a conductive material provided on one surface of a transparent substrate;
a lower electrode portion arranged at a vehicle lower portion of an outer edge portion of the windshield, and electrically connected to the transparent conductive film;
a right electrode portion arranged on the vehicle right side portion of the outer edge portion of the windshield, and electrically connected to the transparent conductive film;
a left electrode portion arranged at a vehicle left side of the outer edge portion of the windshield and electrically connected to the transparent conductive film; and
a control device configured to execute a plurality of energization modes for energizing the transparent conductive film by setting the lower electrode portion, the right electrode portion, and the left electrode portion to a high potential, a low potential, or a non-energizing state, wherein
in a first mode among the plurality of energization modes, one of the right electrode portion and the left electrode portion is set to a high potential and the other is set to a low potential to energize the transparent conductive film,
in a second mode among the plurality of energization modes, at least one of the right electrode portion and the left electrode portion is set to a high potential and the lower electrode portion is set to a low potential, or at least one of the right electrode portion and the left electrode portion is set to a low potential and the lower electrode portion is set to a high potential so as to energize the transparent conductive film, and
the conductive material constituting the transparent conductive film is oriented in a direction oblique to the vertical and horizontal directions of the vehicle.

12. The heater device according to claim 5, wherein
when the control device executes at least one of the plurality of energization modes that prevents window fogging, the air conditioner increases a circulation rate of the air in a vehicle interior to reduce an amount of outside air introduced, or reduces or stops blowing air from a defroster outlet.
